(19) United States
(12) Patent Application Publication
(10) Pub. No.: US 2018/0129759 A1
(43) Pub. Date: May 10, 2018

(54) Systems and Methods for Generating Scalability Models

(71) Applicant: CA, Inc., New York, NY (US)

(72) Inventors: Alex Esterkin, Revere, MA (US); David Rich, Ayer, MA (US); James Mercer, Millville, MA (US)

(73) Assignee: CA, Inc., New York, NY (US)

(21) Appl. No.: 15/346,219

(22) Filed: Nov. 8, 2016

(51) Int. Cl. G06F 17/50; G06N 5/04

(52) U.S. Cl. CPC G06F 17/5009; G06N 5/04

(57) ABSTRACT

A method includes obtaining speed benchmark values and throughput benchmark values for a plurality of computing systems, and generating a plurality of sets of first processor scalability factors. For each set of first processor scalability factors, a predicted throughput value is generated for each computing system based on the set of first processor scalability factors and the speed benchmark value of the computing system. The throughput benchmark value is compared to the predicted throughput value for each of the plurality of computing systems, and a set of first processor scalability factors is identified from among the plurality of sets of first processor scalability factors for which, for a largest number of the computing systems, the predicted throughput value of the computing systems is less than a predetermined difference from the throughput benchmark value of the computing systems.

### BACKGROUND

Various embodiments described herein relate to computer software, and in particular to systems and methods for generating scalability models that can be used for modeling data processing networks.

Information technology (IT) systems include a large number of components, such as servers, storage devices, routers, gateways, and other equipment. When an IT system is designed, an architecture is specified to meet various functional requirements, such as capacity, throughput, availability, and redundancy. In order to determine if a proposed system architecture can meet the functional performance requirements, it is desirable to simulate operation of the system before it is built or modified, as building and testing an IT system before deployment may be cost prohibitive, particularly if a production-like test environment is built. This process is sometimes referred to as performance modeling, which refers to the creation of a computer model that emulates the performance of a computer system.

Performance modeling may be used to test the performance of an IT system before it is built. Performance modeling may be performed as part of capacity management, which requires predicting future needs based on historical results. This approach requires having performance data for the system available in order to calibrate the model. The accuracy of the modeling results depends on the availability of reliable and plausible simulation data.

Performance modeling can also be used to plan for future growth of current systems. Today, most data centers are under-utilized, and server over-provisioning is often used an expensive means to ensure fulfillment of service level agreements (SLAs) in order to keep up with increasing business demands for faster delivery of IT services. Data center growth can cause significant strain on IT budgets and management overhead. IT organizations bear the capital expenditure and operating costs of this equipment, and are looking for safe, predictable and cost-effective ways to consolidate and optimize their data center infrastructure. Many organizations have turned to virtualization to consolidate servers and reclaim precious data center space in hope to realize higher utilization rates and increased operational efficiency. Without proper tools and processes, IT organizations may experience “VM sprawl,” which can increase software license costs and system complexity.

Performance modeling can be used to predict and analyze the effect of various factors on the modeled system. These factors include changes to the input load, or to the configuration of hardware and/or software. Indeed, performance modeling has many benefits, including performance debugging (identifying which, if any, system components are performing at unacceptable levels, and why they are underperforming), capacity planning (applying projected loads to the model to analyze what hardware or configurations would be needed to support the projected load), prospective analysis (the ability to test “what if” scenarios with respect to the system, its configuration, and its workload), and system “health” monitoring (determining whether the computer system is operating according to expected behaviors and levels).

While performance modeling provides tremendous benefits, currently, performance modeling requires a significant amount of effort to select useful models for many of the devices in a data processing system, particularly when scalability is taken into consideration, as the scalability of computer systems is nonlinear. In order to accurately simulate the performance of a computer system in a data processing network, it is helpful to use a model that takes into account the number of chips, cores and active threads that the computer system is capable of utilizing. Because each computer system and/or each processor type is different, each system or processor may respond differently to increases in workloads. Selecting the proper model for each computer system in a data processing network may be a time consuming and complicated task.

FIG. 1 illustrates a server node 50. The server node 50 includes a set of processor chips (e.g., central processing units, or CPUs) 55 arranged on an appropriate electronics hardware platform (not shown) for executing computational and I/O instructions. The hardware platform accommodates on-board dynamic random-access memory 70 accessible by processor chips 55 for dynamic data storage. Attached to processor chips 55 and contained in server node 50 are a set of disk drives 60 for persistent storage of data and typically comprised of magnetic read-write hard drives. Also attached to processor chips 55 and contained within server node 50 are a set of network interface cards NICs 65 which provide a means by which the processor chips 55 may communicate though one or more communication networks.

In migrating from a source data center configuration to a destination data center configuration, a potentially large number of configuration parameters must be specified or computed. The source parameters of the source data center configuration are measured and specified typically as a baseline. The destination parameters of the destination data center configuration may be obtained through simulation of the destination data center configuration.

An IT manager may desire to understand what the performance of the destination data center configuration will be relative to the source data center configuration so as to optimize the destination data center configuration for performance, cost, upgradeability or other features. Some embodiments of the inventive concepts provide the ability to generate a set of models of CPU performance that can be used to evaluate the performance of multichip, multicore, multithread processor configurations and the effect of their performance on the performance of the applications and workloads.

In the case of multicore, multithread processing units, more sophisticated capacity planning and performance engineering tools are needed. Analysis tools in the state of the art may take multiple CPUs into account, but do not take into account non-linear scalability effects when resources such as cache memory and disks are shared by multiple cores and multiple threads.

FIG. 2 illustrates a set of CPU chips 55 that may be included in a computing system. Each CPU chip may include a plurality of microprocessor cores 80. Each microprocessor core may, for example, have its own floating point unit and instruction pipeline. Within each microprocessor core 80, it is possible to fork the instruction pipeline into multiple logical processor threads 85, wherein each processor thread may be activated to execute program instructions for different programs or may be activated to execute parallel processing instructions for a single program.

When processor threads 85 are activated, the operating system will typically allocate tasks to processor threads most efficiently by minimizing the number of active threads per processor chip 55 and minimizing the number of active threads per core 85, so that on-chip resources, such as cache, floating point units, etc., are less likely to be shared. However, as a practical matter, as more cores and threads are utilized, on-chip resources are shared, which means, for example, that activating an additional core or thread does not double the processing power of the chip. Thus, in planning for capacity upgrades, the scalability of a CPU chip is nonlinear and complex.

### SUMMARY

Some embodiments provide methods of generating scalability models for computing systems. The methods may be performed on a computing device. A method according to some embodiments includes obtaining speed benchmark values and throughput benchmark values for a plurality of computing systems, each of the computing systems including a processor, and generating a plurality of sets of first processor scalability factors. For each set of first processor scalability factors, a predicted throughput value is generated for each computing system of the plurality of computing systems based on the set of first processor scalability factors and the speed benchmark value of the computing system. The throughput benchmark value is compared to the predicted throughput value for each of the plurality of computing systems, and a set of first processor scalability factors is identified from among the plurality of sets of first processor scalability factors for which, for a largest number of the computing systems, the predicted throughput value of the computing systems is less than a predetermined difference from the throughput benchmark value of the computing systems.

The method further includes grouping computing systems for which the predicted throughput value is less than the predetermined difference from the throughput benchmark value into a first set and grouping remaining computing systems for which the predicted throughput value is greater than the predetermined difference from the throughput benchmark value into a second set, and assigning the identified set of first processor scalability factors to the computing systems in the first set.

The method may further include dividing the computing systems in the second set into a plurality of third sets of computing systems based on processor type, selecting one set of the plurality of third sets of computing systems, and generating a plurality of sets of second processor scalability factors.

For each set of second processor scalability factors, a predicted throughput value is generated for each of the plurality of computing systems in the selected third set of computing systems based on the set of second processor scalability factors and the speed benchmark value of the respective computing system, and the throughput benchmark value is compared to the predicted throughput value for each of the plurality of computing systems in the selected third set of computing systems. The method further includes identifying a set of second processor scalability factors from among the plurality of sets of second processor scalability factors for which, for a largest number of the computing systems in the selected third set of computing systems, the predicted throughput value of the computing systems is less than the predetermined difference from the throughput benchmark value of the computing systems in the selected third set of computing systems, grouping computing systems for which the predicted throughput value is less than the predetermined difference from the throughput benchmark value into a fourth set and grouping remaining computer systems for which the predicted throughput value is greater than the predetermined difference from the throughput benchmark value into a fifth set, and assigning the identified set of second processor scalability factors to the computing systems in the fourth set.

The identification of second processor scalability factors may be repeated for a plurality of processor types.

The method may further include dividing the computing systems in the fifth set into a plurality of sixth sets of computing systems based on processor series, selecting one set of the plurality of sixth sets of computing systems, and generating a plurality of sets of third processor scalability factors.

For each set of third processor scalability factors, a predicted throughput value may be generated for each of the plurality of computing systems in the selected sixth set of computing systems based on the set of third processor scalability factors and the speed benchmark value of the respective computing system. The method may further include comparing the throughput benchmark value to the predicted throughput value for each of the plurality of computing systems in the selected sixth set of computing systems, identifying a set of third processor scalability factors from among the plurality of sets of third processor scalability factors for which, for a largest number of the computing systems in the selected sixth set of computing systems, the predicted throughput value of the computing systems is less than the predetermined difference from the throughput benchmark value of the computing systems in the selected sixth set of computing systems, grouping computing systems for which the predicted throughput value is less than the predetermined difference from the throughput benchmark value into a seventh set and grouping remaining computer systems for which the predicted throughput value is greater than the predetermined difference from the throughput benchmark value into an eighth set, and assigning the identified set of third processor scalability factors to the computing systems in the seventh set.

The first processor scalability factors may include linear and exponential processor scalability factors. In some embodiments, the first processor scalability factors include chip scalability factors, core scalability factors and/or thread scalability factors.

The method may further include generating individual sets of processor scalability factors for the computer systems in the second set that are different from the identified set of first processor scalability factors.

The method may further include selecting a set of processor scalability factors for use in modeling performance of a first computing system. Selecting the set of processor scalability factors may include determining if an individual set of processor scalability factors has been generated for the first computing system, and in response to determining that an individual set of processor scalability factors has not been generated for the first computing system, selecting the identified set of first processor scalability factors for use in modeling performance of the first computing system.

The method may further include generating individual sets of processor scalability factors for the computer systems in the second set that are different from the identified set of first processor scalability factors, and selecting a set of processor scalability factors for use in modeling performance of a first computing system. Selecting the set of processor scalability factors may include determining if an individual set of processor scalability factors has been generated for the first computing system, and in response to determining that an individual set of processor scalability factors has not been generated for the first computing system, determining a processor type of the first computing system, determining if the identified second set of processor scalability factors corresponds to the processor type of the first computing system, and in response to determining that the second set of processor scalability factors corresponds to the processor type of the first computing system, selecting the identified set of second processor scalability factors for use in modeling performance of the first computing system.

A method according to further embodiments includes identifying a generic scalability model including a set of generic processor scalability factors that models performance of a number of computing systems out of a set of computing systems to within a predefined accuracy, determining if any computing systems of the set of computing systems exist that are not modeled by the set of generic processor scalability factors to within the predefined accuracy, and in response to determining that at least some computing systems of the set of computing systems are not modeled by the set of generic processor scalability factors to within the predefined accuracy, dividing the at least some computing systems into a plurality of groups based on a plurality of processor types, and identifying general scalability models including sets of processor scalability factors for each of the plurality of processor types, wherein the general scalability models model performance of a plurality of computing systems of the respective plurality of groups to within the predefined accuracy.

Related systems and computer program products are provided.

It is noted that aspects described herein with respect to one embodiment may be incorporated in different embodiments although not specifically described relative thereto. That is, all embodiments and/or features of any embodiments can be combined in any way and/or combination. Moreover, other systems, methods, and/or computer program products according to embodiments will be or become apparent to one with skill in the art upon review of the following drawings and detailed description. It is intended that all such additional systems, methods, and/or computer program products be included within this description, be within the scope of the present disclosure, and be protected by the accompanying claims.

### BRIEF DESCRIPTION OF THE DRAWINGS

Aspects described herein are illustrated by way of example and are not limited by the accompanying figures, with like references indicating like elements.

FIG. 1 is a block diagram showing the components of a server node within a data center configuration.

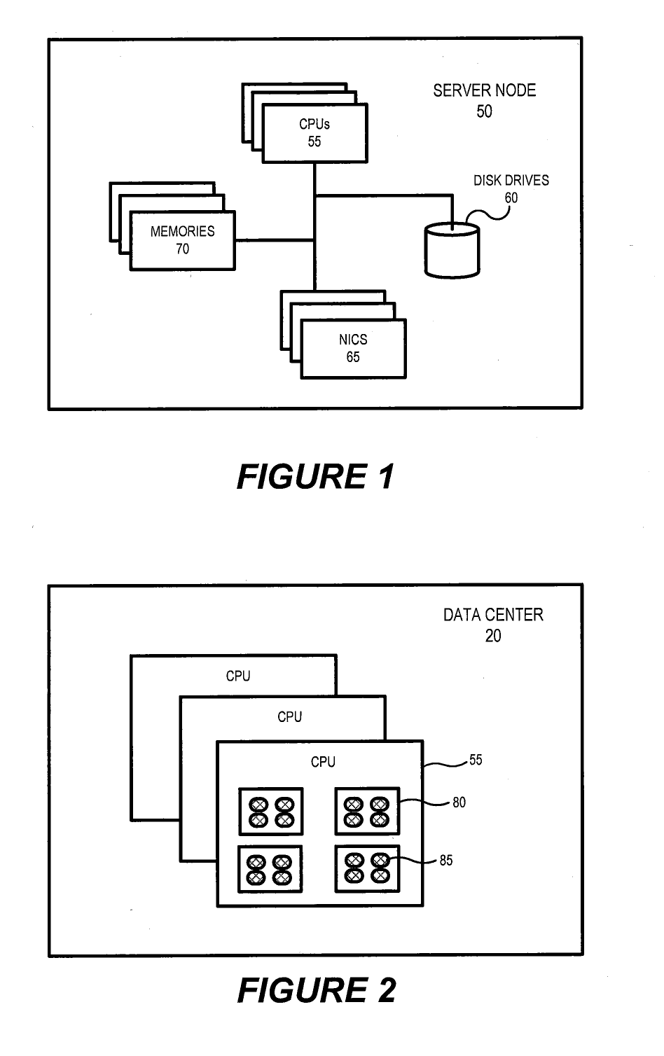

FIG. 2 is a block diagram showing CPU architecture incorporating multiple chips, multiple cores and multiple threads per core.

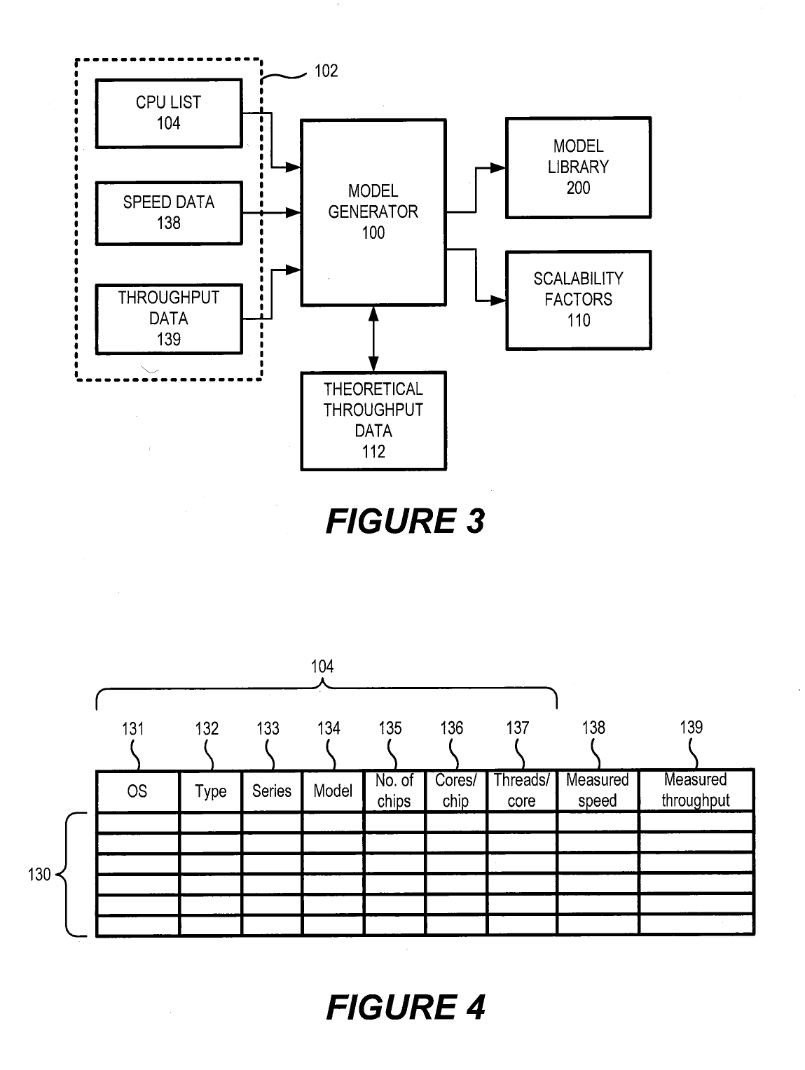

FIG. 3 is a block diagram of a CPU model generator in accordance with some embodiments.

FIG. 4 illustrates a repository of CPU data including speed and throughput data.

FIG. 5 is a flowchart illustrating the determination of scalability factors from existing CPU performance data.

FIG. 6 illustrates a repository of CPU data including theoretical throughput data generated using a plurality of scalability models.

FIGS. 7A and 7B are flowcharts illustrating the generation of CPU models according to various embodiments.

FIGS. 8A and 8B are flowcharts that illustrate the selection of CPU models according to some embodiments.

FIG. 9 is a diagram that graphically illustrates the selection of CPU models according to some embodiments.

FIG. 10 is a block diagram of an CPU model generator that is configured according to various embodiments.

FIG. 11 is a block diagram depicting a server migration from a source data center to a destination data center using CPU models generated in accordance with various embodiments.

### DETAILED DESCRIPTION

Some embodiments of the inventive concepts provide systems and methods that generate CPU models that can be used in the simulation of data processing system architectures in the design, planning or production phase. Various embodiments disclosed herein generate nonlinear model parameters that can be used to simulate the operation of large numbers of processors.

The embodiments described herein can make the process of performance modeling faster and/or more efficient by reducing the number of models that need to be considered in generating a system model.

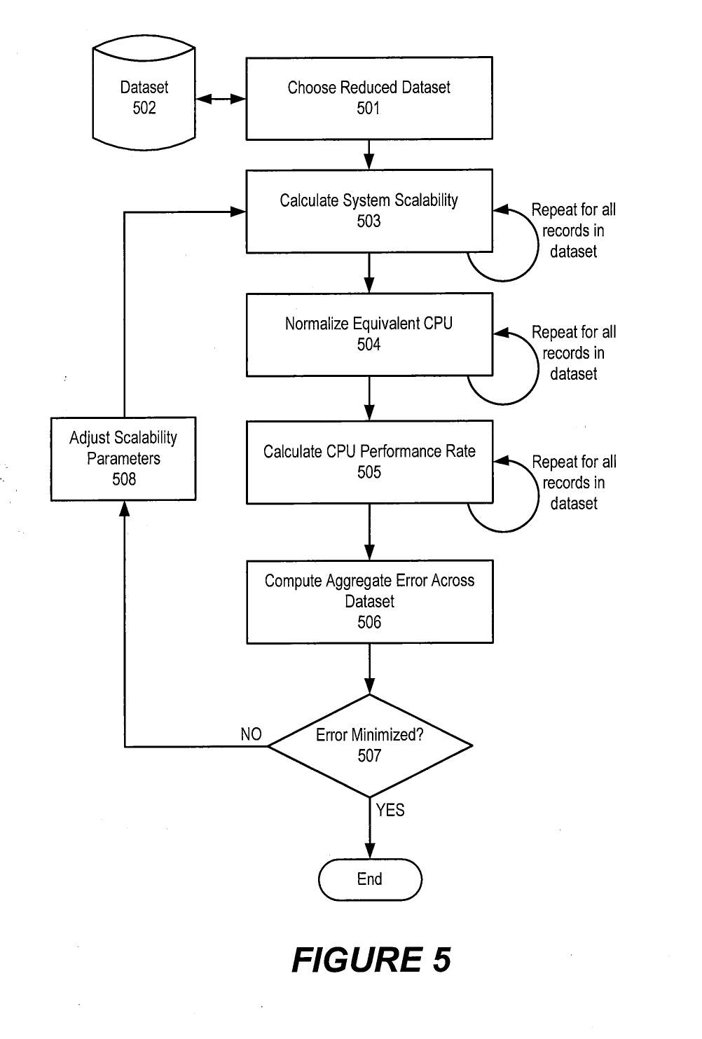

FIG. 3 is a functional block diagram illustrating a CPU model generator 100 according to some embodiments. A model generator 100 according to some embodiments receives inputs from a repository 102 that includes a list 104 of CPUs, along with measured speed data 138 and measured throughput data 139 for the CPUs. The list of CPUs may be organized, for example, according to a taxonomy that organizes the CPUs into a hierarchical arrangement, for example, by processor type, processor series and/or processor model. Other categories can be used to organized the processors, such as manufacturer, operating system, word length, processor speed, etc.

In some embodiments, each processor may have a processor type. Each processor type may be further subdivided into one or more processor series, and each processor series may be further subdivided into one or more processor models. Thus, each processor may have an associated processor model, processor series and processor type.

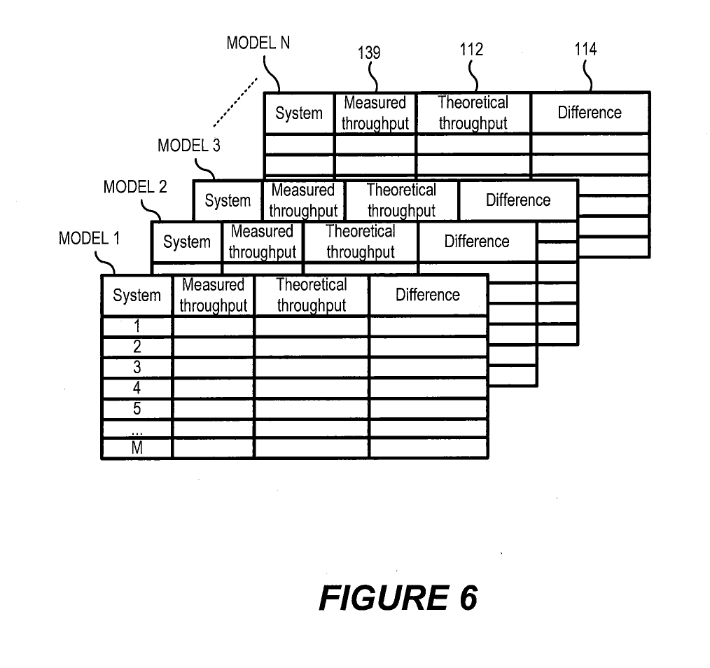

FIG. 4 shows CPU performance and taxonomy data in the internal repository 102. CPU performance data is tabulated into a set of records 130, wherein each record represents a system configuration containing at least an operating system type 131, a processor type 132, a processor series 133, a processor model 134, a number of chips in the system 135, a number of cores per chip 136, a number of processor threads per core 137, a measured single thread speed performance S meas 138 and at least one measured throughput performance rate R_meas 139. The measured performances 138 and 139 may be the SPECint2006 and the SPECint_rate2006 from Standard Performance Evaluation Corporation. In some embodiments, the values of SPECint2006 and SPECint_rate2006 may be periodically scraped from the SPEC web site to ensure that the speed data 138 and throughput data 139 are up to date. SPECint_rate2006 measures the CPU performance in cases where multiple CPUs, multiple cores and multiple threads are in use. Of course, this performance data may be obtained from other sources such as actual lab measurements or from systems manufacturers.

After the CPU performance data has been stored in the internal repository 102, the model generator 100 analyzes the CPU performance data to create an eight parameter scalability fit in a scalability modeling process, as described below. The eight scalability parameters are determined for each system of interest in the internal repository 102 and stored as scalability factors 110. In practice, the stored scalability factors 110 may be stored as separate columns in the repository 102. The scalability factors determine a linear and an exponential fit to each of four system CPU characteristics, including the operating system (OS) scalability, chip scalability, core scalability and thread scalability.

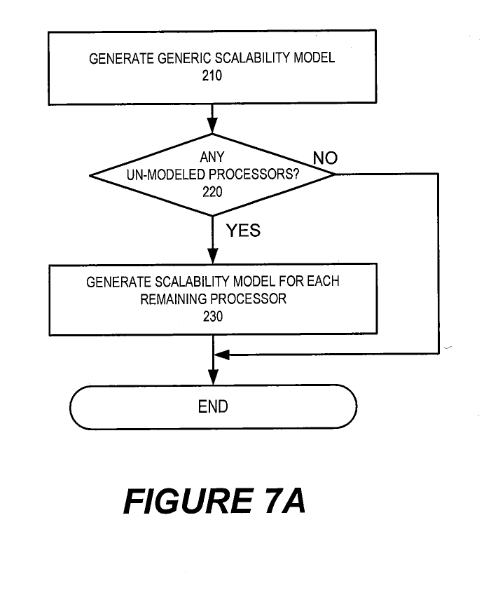

The generation of scalability factors from performance data is described in detail in U.S. Publication No. 2009/0055823, the disclosure of which is incorporated herein by reference in its entirety. The generation of scalability factors from performance data will now be described briefly with reference to FIG. 5. Referring to FIG. 5 the method 500 begins at block 501 in which a dataset 502 of CPUs is provided. The dataset 502 may include groups of records sharing a common feature such as operating system type or processor type. At block 503, the system scalability is calculated according to the formula for “System_Scalability” given in Table 1, below, where N[2] is taken as the number of processor chips 135, N[3] is taken as the number of cores per chip 136, N[4] is taken as the number of threads per core, and

N[1]=N[2]*N[3]*N[4],

is the total number of threads at which the multithread performance 139 is measured.

TABLE 1

| | Linear Scalability | Exponential | |
|---|---|---|---|
| Entity | Factors | Scalability Factors | Scale Factors |
| OS | L[1] | α[1] | N[1] = total number |
| | | | of active threads |
| | | | servicing CPU |
| | | | requests in the |
| | | | system |
| Chip | L[2] | α[2] | N[2] = number of |
| (CPU) | | | CPU chips having |
| | | | active threads |
| Core | L[3] | α[3] | N[3] = number of |
| | | | cores/chip having |
| | | | active threads |
| Thread | L[4] | α[4] | N[4] = number of |
| | | | active threads/core |
| | | | utilized |

EffectiveNElements[i] = (1 + L[i] * (N[i] − 1)) * α^{(N[i]-1)}
Scalability[i] = EffectiveNElements[i]/N[i]
System_Scalability = ΠᵢScalability[i]

Block 503 is then repeated for all records in the dataset 502.

In block 504, the system_{—} scalability is normalized according to the equation:

Equiv_CPU=System_Scalability*N[1]

Block 504 is repeated for all records in the dataset 502. In block 505, the computed performance S meas rate, R_calc is calculated from the measured single threaded performance, S_meas, for the first record in dataset 502 according to

R_calc=S_meas*Equiv_CPU

Block 505 is repeated for all records in dataset 502. In block 506, the least squares error between a measured performance rate R_meas 139 and the computed performance rate R_calc is calculated for each record and summed over all records, r, according to:

$$error = \frac{{\sum }_{r} {( R\_calc - R\_meas )}^{2}}{{( R\_meas )}^{2}}$$

R_meas for each record is obtained from known sources of performance data such as the manufacturer of each system. S_meas is commonly referred to in the art as SPECint data. R_meas is commonly referred to in the art as SPECint_rate data. The error is checked to be minimal in block 507 by comparison against a predetermined standard and if not acceptable, the process continues at block 508. At block 508, calculation of the scalability factor according to process 500 is repeated. If the error is determined to be acceptable, process 500 ends at block 509. The criteria for minimization may be an error ≤1% or a given number of iterations on the dataset 502, such as 10 or less.

The error may be determined by a least squares method or any other suitable measures of goodness of fit.

A different set of scalability factors may be generated for each CPU in the repository 102. However, it will be appreciated that there may be thousands or even tens of thousands of entries in the repository 102. In the process of modeling a computing system, it may be necessary to maintain models for many types of processors and systems. This can be cumbersome and raise serious usability issues for a performance modeling system.

Some embodiments provide methods of generating generic models that can be used to model classes or groups of CPUs with a high, or at least acceptable, level of accuracy. By providing generic models that can be used to model large groups, or classes, of CPUs, the number of models that must be considered by a performance modeler may be greatly reduced, which can make the maintenance of model libraries considerably easier, and can also make the process of matching models to systems considerably simpler.

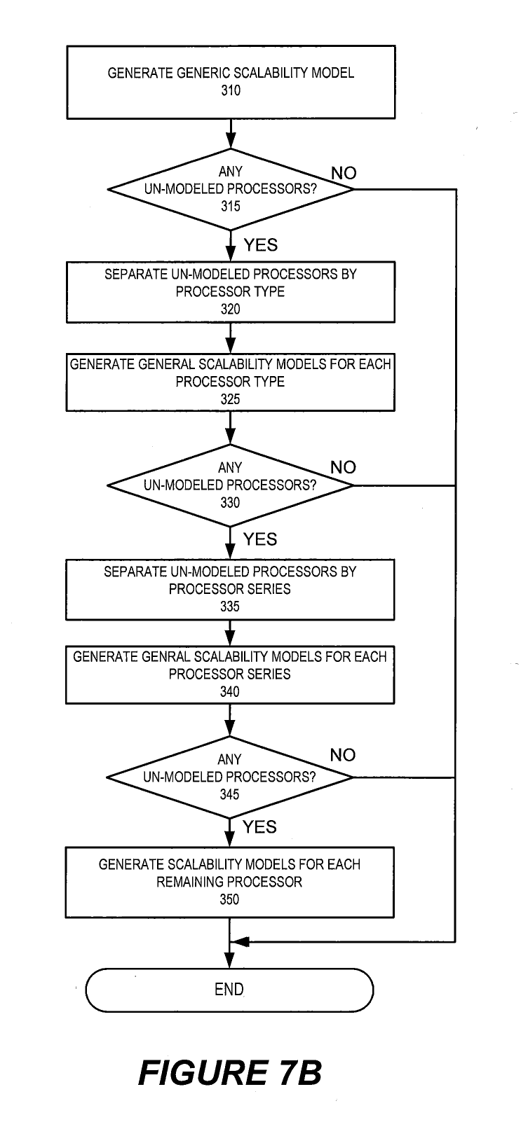

According to some embodiments, measured speed 138 and throughput 139 data for each system is obtained for a plurality of systems, such as is shown in FIG. 4. A plurality of sets of scalability factors, including at least chip, core and thread scalability factors, are generated and stored by the model generator 100. Each set of scalability factors is referred to herein as a “scalability model.” Referring now to FIG. 6, assuming that M sets of systems are being modeled, for each system (e.g., for each record 130 in the CPU list 104 of FIG. 4), a theoretically projected value of throughput 112 is calculated using each of the models (i.e., each of the stored sets of scalability factors.) For example, the model generator 100 may generate N unique sets of scalability factors, or N scalability models. Using each of the N scalability models, a theoretical throughput value 112 is calculated for each of the M systems. Then, a difference 114 between the theoretical and measured throughput values is calculated and recorded for each system and for each model.

For each of the N scalability models, a total number of systems is identified for which the difference between the theoretical and measured throughput values is less than or equal to a predetermined threshold amount. For example, the threshold may be 10%, although other thresholds may be used depending on design requirements. For each scalability model a count is made of systems for which the difference between the theoretical 112 and measured 139 throughput values is less than or equal to the threshold. The scalability model for which the count is a maximum is selected as a default model for the M systems, and the default model is stored in the model library 200.

In this manner, the scalability model, including chip, core and thread scalability factors that adequately match a largest number of systems, may be identified. The default scalability model may then be associated in the repository 102 with each of the systems for which the difference between the measured throughput values differ from theoretical throughput values calculated using the default scalability model was less than the threshold.

In some embodiments, an individual analysis may be performed to generate individual scalability models for each of the remaining systems, that is, for each of the systems for which the difference between the measured throughput values differ from the theoretical throughput values generated using the default scalability model is greater than the threshold.

In other embodiments, the remaining systems may be grouped by processor type, and a process similar to that described above may be performed for all processors in each group. That is, for each processor type, a default or generic scalability model may be generated as described above. Any remaining processors of each processor type that are not adequately modeled by the generic scalability model for the selected processor type may be divided by processor series, and the process may be repeated to identify a generic or default scalability model for each processor series. This process may be repeated for as many levels as there are in the taxonomy of systems.

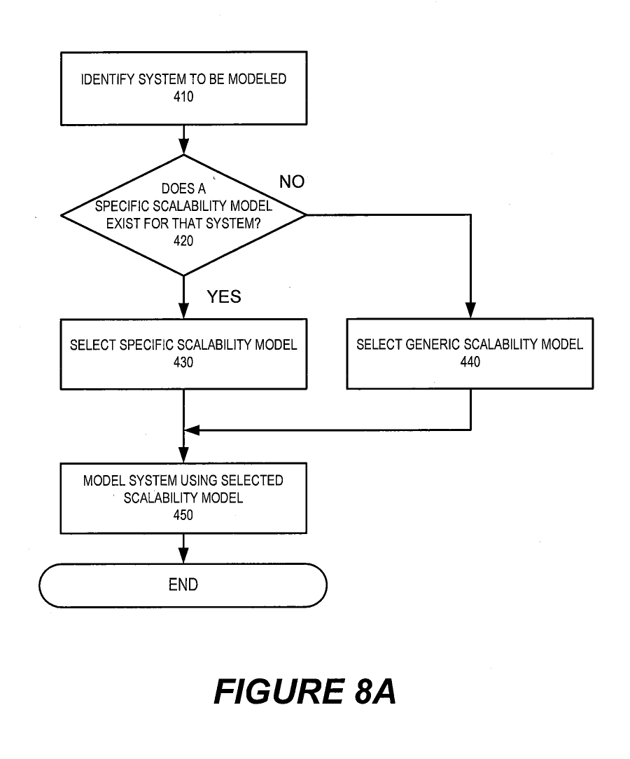

FIGS. 7A and 7B are flowcharts illustrating the generation of CPU models according to various embodiments. Referring to FIG. 7A, a generic scalability model is generated as described above (Block 210). The operations then determine in Block 220 if there are any processors remaining that are not modeled by the generic scalability model. If so, individual scalability models are then generated for each remaining processor (Block 230). Otherwise, operations terminate.

Referring to FIG. 7B, the generation of CPU models according to further embodiments is illustrated. Initially, a generic scalability model is generated as described above (Block 310). Next, the operations determine if there are any remaining un-modeled processors (Block 315). That is, the system determines if there are any processors for which the generic scalability model does not predict system performance within the selected threshold. If there are no remaining un-modeled processors, operations terminate.

If there are un-modeled processors remaining, operations proceed to Block 320, where the remaining un-modeled processors are separated by processor type. General scalability models for each processor type are then generated in Block 325 for each processor type for which un-modeled processors remain.

Next, the operations determine if there are any remaining un-modeled processors (Block 330). That is, the system determines if there are any processors for which the general scalability models generated at Block 325 do not predict system performance within the selected threshold. If there are no remaining un-modeled processors, operations terminate.

If there are un-modeled processors remaining, operations proceed to Block 335, where the remaining un-modeled processors are separated by processor series. General scalability models for each processor series are then generated in Block 340 for each processor series for which un-modeled processors remain.

Next, the operations determine if there are still any remaining un-modeled processors (Block 345). That is, the system determines if there are any processors for which the general scalability models generated at Block 340 do not predict system performance within the selected threshold. If there are no remaining un-modeled processors, operations terminate.

If there are un-modeled processors remaining, operations proceed to Block 350, where individual scalability models are generated for the remaining un-modeled processors.

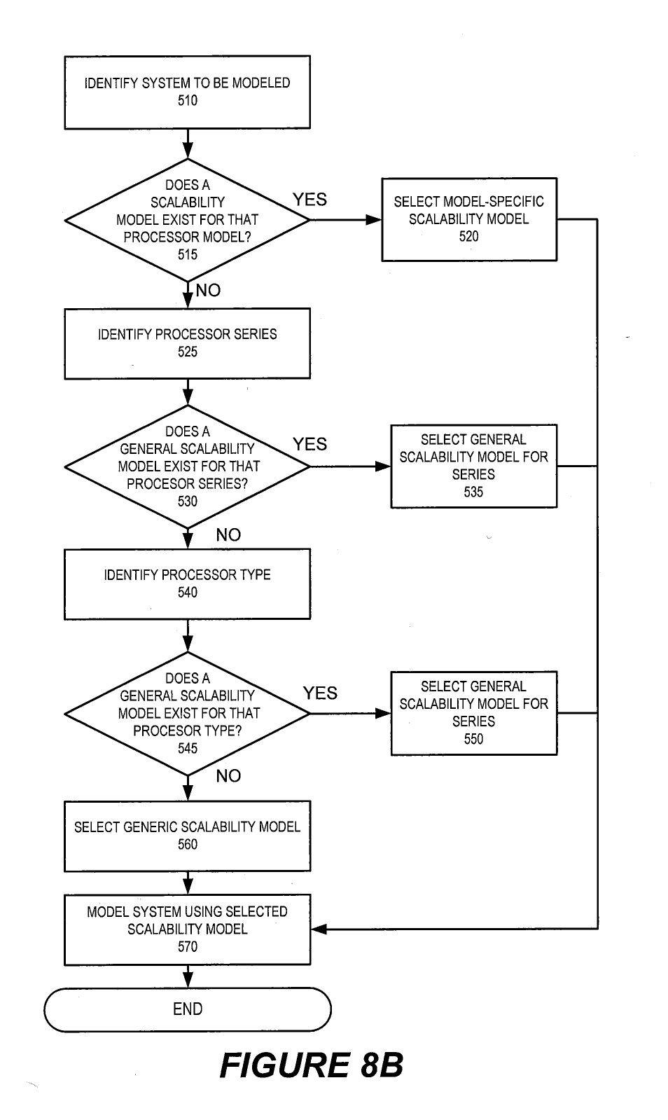

After one or more generic and/or general models have been generated, they may be used in a performance modeling system. FIG. 8A illustrates selection of a scalability model for embodiments in which a single generic scalability model is generated and individual scalability models are generated for all systems for which the generic scalability model is not adequate. That is, FIG. 8A illustrates embodiments in which a single generic scalability model is generated, and systems for which the generic scalability model does not accurately predict throughput are modeled individually.

Referring to FIG. 8A, the operations begin by identifying the processor to be modeled (Block 410). The operations then determine if a specific scalability model exists for the processor (Block 420). If a specific scalability model does exist for the processor, that scalability model is selected at Block 430. However, if a specific scalability model does not exist for the processor, the generic scalability model is selected at Block 440. The selected scalability model is then used to model the processor in question.

FIG. 8B illustrates the selection of a scalability model when a hierarchy of scalability models has been generated. Referring to FIG. 8B, the operations begin by identifying the processor to be modeled (Block 510). The operations then determine if a specific scalability model exists for the processor (Block 515). If a specific scalability model does exist for the processor, that scalability model is selected at Block 520. However, if a specific scalability model does not exist for the processor, operations proceed to Block 525, where the system identifies the processor series associated with the processor. The processor series can be found, for example, from a lookup table, or may be stored in the CPU list 104 in the repository 102 (FIG. 3).

The operations then determine if a general scalability model exists for the processor series to which the selected processor belongs (Block 530). If a general scalability model does exist for the processor series, that scalability model is selected at Block 535. However, if a general scalability model does not exist for the processor series, operations proceed to Block 540, where the system identifies the processor type associated with the selected processor. The processor type can be found, for example, from a lookup table, or may be stored in the CPU list 104 in the repository 102 (FIG. 3).

The operations then determine if a general scalability model exists for the processor type to which the selected processor belongs (Block 545). If a general scalability model does exist for the processor type, that scalability model is selected at Block 550. However, if a general scalability model does not exist for the processor type, operations proceed to Block 560, where the generic scalability model is selected.

The system is then modeled using the selected scalability model at Block 570.

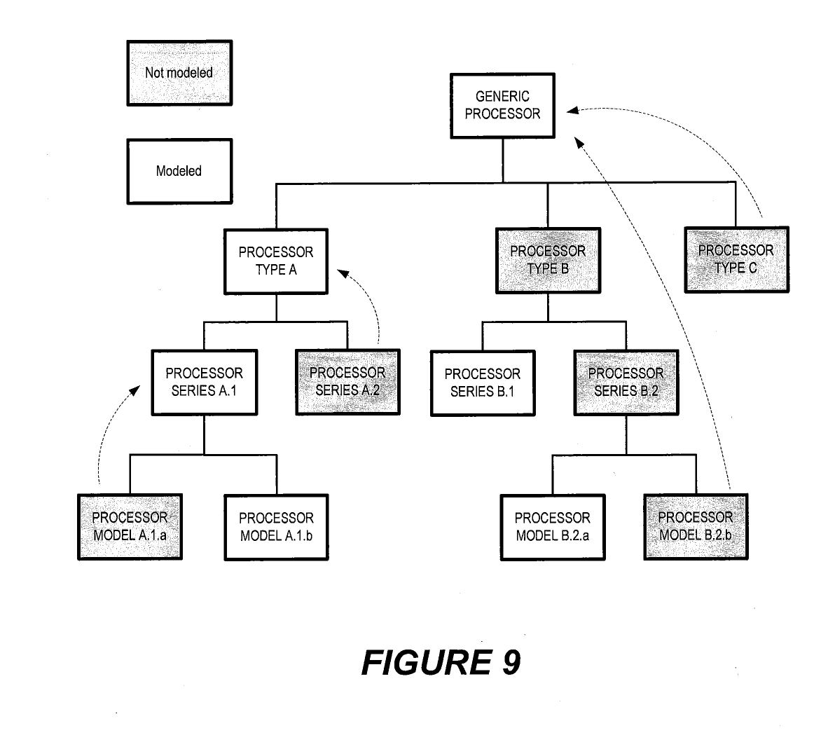

FIG. 9 is a diagram that graphically illustrates the selection of scalability models for use in performance modeling according to embodiments in which a hierarchy of general scalability models are generated. In the illustration of FIG. 9, all processors are divided into three Processor Types, namely, Processor Types A, B and C. Processor Type A is further subdivided into Processor Series A.1 and Processor Series A.2. Similarly, Processor Type B is further subdivided into Processor Series B.1 and Processor Series B.2. Processor Series A.1 includes Processor Models A.1.a and A.1.b. Similarly, Processor Series B.2 includes Processor Models B.2.a and B.2.b. It will be appreciated, however, that many other models are not illustrated in FIG. 7A. For example, there may be a number of models of Processor Type C or Processor Series A.2 that are not illustrated.

In FIG. 9, boxes that are un-shaded, such as for the Generic Processor, indicates that a generic scalability model has been created for that category, or in the case of specific Processor Models, that a specific scalability model has been created for that Processor Model. Shading, such as for Processor Type C, indicates that no generic scalability model has been created for that category.

In order to select a model for a given processor, it is first determined if a scalability model exists for the processor model in question. If no scalability model exists, the operations move one step up the hierarchy and determine if a scalability model exists for the series to which the processor belongs. If so, that scalability model is used. Otherwise, the operations move up another step in the hierarchy, and the process is repeated, until the highest level of the hierarchy is reached, at which point the generic scalability model is chosen to represent the processor in question.

For example, assume that it is desired to find a scalability model for a processor of Model A.1.b As shown in FIG. 9, a scalability model exists for that particular model, so that scalability model would be chosen. Assume further that it is desired to find a scalability model for a processor of Model A.1.a. As shown in FIG. 9, no scalability model exists for that particular model, so operations proceed to the next level of the hierarchy, namely, the Processor Series level. At that level, it is seen that there is a general scalability model for Processors of Series A.1. Thus, that scalability model is chosen for use in modeling the Model A.1.a processor.

As another example, assume that is desired to find a scalability model for a processor of Model B.2.b. As shown in FIG. 9, no scalability model exists for that particular model, so operations proceed to the next level of the hierarchy, namely, the Processor Series level. At that level, it is seen that there is no general scalability model for processors of Processor Series B.2, so operations proceed to the next level of the hierarchy, namely, the Processor Type level. However, it is also seen that there is no general scalability model for processors of Processor Type B. Thus, operations proceed to the next level of the hierarchy, where the generic processor model is chosen.

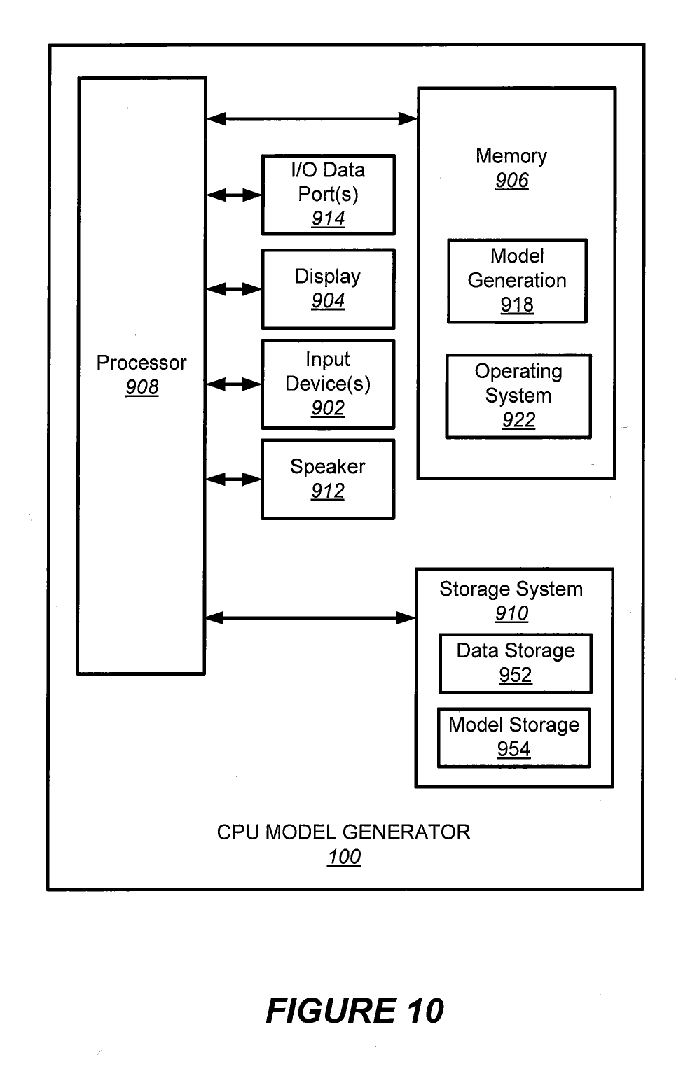

FIG. 10 is a block diagram of a CPU model generator 100 that is configured according to various embodiments. The CPU model generator 100 may implement the operations illustrated in FIGS. 8A and 8B. The CPU model generator 100 includes a processor 908 that communicates with a memory 906, a storage system 910, and one or more I/O data ports 914. The CPU model generator 100 may also include a display 904, an input device 902 and a speaker 912. The memory 906 stores program instructions and/or data that configure the CPU model generator 100 for operation. In particular, the memory 906 may store a model generation module 918 and an operating system module 922. The model generation module 918 may configure the CPU model generator to perform the operations illustrated in any of FIGS. 5, 7A, 7B, 8A or 8B as described above.

The storage system 910 may include, for example, a hard disk drive or a solid state drive, and may a data storage 952 for storing generated events and a model storage 954 for storing the event models.

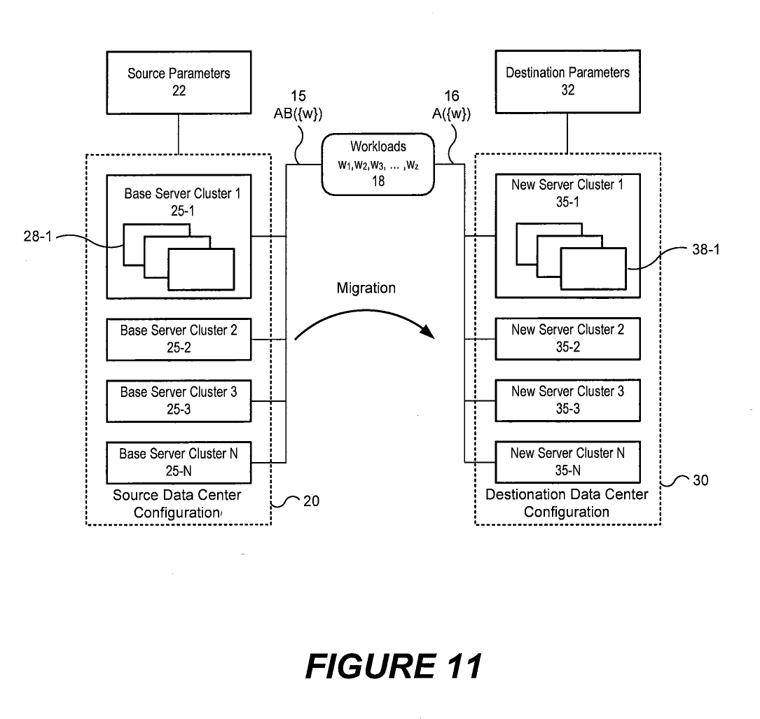

Once models have been generated as described above, the models may be used to simulate performance of a destination data center configuration and to migrate from a source data center configuration to a destination data center configuration. Accordingly, some embodiments of the inventive concepts facilitate the evaluation of the performance effects of anticipated changes to workloads, applications and infrastructure, such as during a data center server migration as illustrated in FIG. 11. As shown in FIG. 11, a source or base data center configuration 20 is to be changed to a destination data center configuration 30. A set of Z workloads 18 defined as {w}=w₁, w₂, . . . w_{Z} are arriving at source data center configuration 20 at base arrival rates AB({w}) 15 during a base time interval. Workloads 18 are requests for specific computer instructions to be processed by the base data center. For example, the workloads may be generated by a number of internet users simultaneously utilizing their web browsers to view and interact with web content from a particular company's web servers such as viewing catalogs of merchandise, investigating online specifications, placing orders or providing online payments. A destination data center configuration 30 is prescribed to accept workloads 18 at a set of arrival rates A({w}) 16 where A({w}) 16 is scaled from base arrival rates AB({w}) by some scaling factor G({w}), where G(w)=1 represents the processing of the workloads by the destination data center configuration at the base (original) workload arrival rates.

The source data center configuration 20 includes a set of N server clusters 25-1, 25-2, . . . 25-N. Furthermore, the server cluster 25-1 includes a set of server nodes 28-1. Similarly, server clusters 25-1, . . . 25-N contain sets of server nodes 28-2, . . . 28-N (not shown). Server clusters 25-1, . . . 25-N functionally operate to service the workloads 18 at arrival rates AB({w}) 15. Source parameters 22 describe configuration parameters of the source data center configuration 20.

The destination data center configuration 30 includes a set of M server clusters 35-1, 35-2, . . . 35-M. The server cluster 35-1 includes a set of server nodes 38-1, and similarly, the server clusters 35-2, . . . 35-M contain sets of server nodes 38-2, . . . 38-M (not shown). The server clusters 35-1, . . . 35-M functionally operate to service workloads 18 at arrival rates A({w}) 16. It will be appreciated that either the source data center configuration 20 or the destination data center configuration 30 may contain only one server node. The destination parameters 32 describe the source data center configuration 30.

To understand what the performance of the destination data center configuration will be relative to the source data center configuration so as to optimize the destination data center configuration for performance, cost, upgradeability or other features, the models generated according to embodiments of the inventive concepts may be utilized. That is, a set of models of CPU performance generated as described above can be used to evaluate the performance of multichip, multicore, multithread processor configurations and the effect of their performance on the performance of the applications and workloads in the destination data center configuration.

### Further Definitions and Embodiments

In the above-description of various embodiments, various aspects may be illustrated and described herein in any of a number of patentable classes or contexts including any new and useful process, machine, manufacture, or composition of matter, or any new and useful improvement thereof. Accordingly, various embodiments described herein may be implemented entirely by hardware, entirely by software (including firmware, resident software, micro-code, etc.) or by combining software and hardware implementation that may all generally be referred to herein as a “circuit,” “module,” “component,” or “system.” Furthermore, various embodiments described herein may take the form of a computer program product comprising one or more computer readable media having computer readable program code embodied thereon.

Any combination of one or more computer readable media may be used. The computer readable media may be a computer readable signal medium or a non-transitory computer readable storage medium. A computer readable storage medium may be, for example, but not limited to, an electronic, magnetic, optical, electromagnetic, or semiconductor system, apparatus, or device, or any suitable combination of the foregoing. More specific examples (a non-exhaustive list) of the computer readable storage medium would include the following: a portable computer diskette, a hard disk, a random access memory (RAM), a read-only memory (ROM), an erasable programmable read-only memory (EPROM or Flash memory), an appropriate optical fiber with a repeater, a portable compact disc read-only memory (CD-ROM), an optical storage device, a magnetic storage device, or any suitable combination of the foregoing. In the context of this document, a computer readable storage medium may be any tangible non-transitory medium that can contain, or store a program for use by or in connection with an instruction execution system, apparatus, or device.

A computer readable signal medium may include a propagated data signal with computer readable program code embodied therein, for example, in baseband or as part of a carrier wave. Such a propagated signal may take any of a variety of forms, including, but not limited to, electro-magnetic, optical, or any suitable combination thereof. A computer readable signal medium may be any computer readable medium that is not a computer readable storage medium and that can communicate, propagate, or transport a program for use by or in connection with an instruction execution system, apparatus, or device. Program code embodied on a computer readable signal medium may be transmitted using any appropriate medium, including but not limited to wireless, wireline, optical fiber cable, RF, etc., or any suitable combination of the foregoing.

Computer program code for carrying out operations for aspects of the present disclosure may be written in any combination of one or more programming languages, including an object oriented programming language such as Java, Scala, Smalltalk, Eiffel, JADE, Emerald, C++, C#, VB.NET, Python or the like, conventional procedural programming languages, such as the “C” programming language, Visual Basic, Fortran 2003, Perl, COBOL 2002, PHP, ABAP, dynamic programming languages such as Python, Ruby and Groovy, or other programming languages. The program code may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider) or in a cloud computing environment or offered as a service such as a Software as a Service (SaaS).

Various embodiments were described herein with reference to flowchart illustrations and/or block diagrams of methods, apparatus (systems), devices and computer program products according to various embodiments described herein. It will be understood that each block of the flowchart illustrations and/or block diagrams, and combinations of blocks in the flowchart illustrations and/or block diagrams, can be implemented by computer program instructions. These computer program instructions may be provided to a processor of a general purpose computer, special purpose computer, or other programmable data processing apparatus to produce a machine, such that the instructions, which execute via the processor of the computer or other programmable instruction execution apparatus, create a mechanism for implementing the functions/acts specified in the flowchart and/or block diagram block or blocks.

These computer program instructions may also be stored in a non-transitory computer readable medium that when executed can direct a computer, other programmable data processing apparatus, or other devices to function in a particular manner, such that the instructions when stored in the computer readable medium produce an article of manufacture including instructions which when executed, cause a computer to implement the function/act specified in the flowchart and/or block diagram block or blocks. The computer program instructions may also be loaded onto a computer, other programmable instruction execution apparatus, or other devices to cause a series of operational steps to be performed on the computer, other programmable apparatuses or other devices to produce a computer implemented process such that the instructions which execute on the computer or other programmable apparatus provide processes for implementing the functions/acts specified in the flowchart and/or block diagram block or blocks.

The flowchart and block diagrams in the figures illustrate the architecture, functionality, and operation of possible implementations of systems, methods, and computer program products according to various aspects of the present disclosure. In this regard, each block in the flowchart or block diagrams may represent a module, segment, or portion of code, which comprises one or more executable instructions for implementing the specified logical function(s). It should also be noted that, in some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts, or combinations of special purpose hardware and computer instructions.

The terminology used herein is for the purpose of describing particular aspects only and is not intended to be limiting of the disclosure. As used herein, the singular forms “a”, “an” and “the” are intended to include the plural forms as well, unless the context clearly indicates otherwise. It will be further understood that the terms “comprises” and/or “comprising,” when used in this specification, specify the presence of stated features, steps, operations, elements, and/or components, but do not preclude the presence or addition of one or more other features, steps, operations, elements, components, and/or groups thereof. As used herein, the term “and/or” includes any and all combinations of one or more of the associated listed items and may be designated as “/”. Like reference numbers signify like elements throughout the description of the figures.

The description herein has been presented for purposes of illustration and description, but is not intended to be exhaustive or limited to the disclosure in the form disclosed. Many modifications and variations will be apparent to those of ordinary skill in the art without departing from the scope and spirit of the disclosure. The aspects of the disclosure herein were chosen and described in order to best explain the principles of the disclosure and the practical application, and to enable others of ordinary skill in the art to understand the disclosure with various modifications as are suited to the particular use contemplated.

What is claimed:

1. A method, comprising:
performing operations as follows on a computing device:
obtaining speed benchmark values and throughput benchmark values for a plurality of computing systems, each of the computing systems comprising a processor;
generating a plurality of sets of first processor scalability factors;
for each set of first processor scalability factors:
(a) for each computing system of the plurality of computing systems, generating a predicted throughput value based on the set of first processor scalability factors and the speed benchmark value of the computing system; and
(b) comparing the throughput benchmark value to the predicted throughput value for each of the plurality of computing systems;
identifying a set of first processor scalability factors from among the plurality of sets of first processor scalability factors for which, for a largest number of the computing systems, the predicted throughput value of the computing systems is less than a predetermined difference from the throughput benchmark value of the computing systems;
grouping computing systems for which the predicted throughput value is less than the predetermined difference from the throughput benchmark value into a first set and grouping remaining computing systems for which the predicted throughput value is greater than the predetermined difference from the throughput benchmark value into a second set; and
assigning the identified set of first processor scalability factors to the computing systems in the first set.

2. The method of claim 1, further comprising:
dividing the computing systems in the second set into a plurality of third sets of computing systems based on processor type;
selecting one set of the plurality of third sets of computing systems;
generating a plurality of sets of second processor scalability factors;
for each set of second processor scalability factors:
(c) generating a predicted throughput value for each of the plurality of computing systems in the selected third set of computing systems based on the set of second processor scalability factors and the speed benchmark value of the respective computing system; and
(d) comparing the throughput benchmark value to the predicted throughput value for each of the plurality of computing systems in the selected third set of computing systems;
identifying a set of second processor scalability factors from among the plurality of sets of second processor scalability factors for which, for a largest number of the computing systems in the selected third set of computing systems, the predicted throughput value of the computing systems is less than the predetermined difference from the throughput benchmark value of the computing systems in the selected third set of computing systems;
grouping computing systems for which the predicted throughput value is less than the predetermined difference from the throughput benchmark value into a fourth set and grouping remaining computer systems for which the predicted throughput value is greater than the predetermined difference from the throughput benchmark value into a fifth set; and
assigning the identified set of second processor scalability factors to the computing systems in the fourth set.

3. The method of claim 2, further comprising repeating the identification of second processor scalability factors for a plurality of processor types.

4. The method of claim 2, further comprising:
dividing the computing systems in the fifth set into a plurality of sixth sets of computing systems based on processor series;
selecting one set of the plurality of sixth sets of computing systems;
generating a plurality of sets of third processor scalability factors;
for each set of third processor scalability factors:
(e) generating a predicted throughput value for each of the plurality of computing systems in the selected sixth set of computing systems based on the set of third processor scalability factors and the speed benchmark value of the respective computing system; and
(f) comparing the throughput benchmark value to the predicted throughput value for each of the plurality of computing systems in the selected sixth set of computing systems;
identifying a set of third processor scalability factors from among the plurality of sets of third processor scalability factors for which, for a largest number of the computing systems in the selected sixth set of computing systems, the predicted throughput value of the computing systems is less than the predetermined difference from the throughput benchmark value of the computing systems in the selected sixth set of computing systems;
grouping computing systems for which the predicted throughput value is less than the predetermined difference from the throughput benchmark value into a seventh set and grouping remaining computer systems for which the predicted throughput value is greater than the predetermined difference from the throughput benchmark value into an eighth set; and
assigning the identified set of third processor scalability factors to the computing systems in the seventh set.

5. The method of claim 1, wherein the first processor scalability factors comprise linear and exponential processor scalability factors.

6. The method of claim 1, wherein the first processor scalability factors comprise chip scalability factors, core scalability factors and/or thread scalability factors.

7. The method of claim 1, further comprising:
generating individual sets of processor scalability factors for the computer systems in the second set that are different from the identified set of first processor scalability factors.

8. The method of claim 7, further comprising selecting a set of processor scalability factors for use in modeling performance of a first computing system, wherein selecting the set of processor scalability factors comprises:
determining if an individual set of processor scalability factors has been generated for the first computing system; and
in response to determining that an individual set of processor scalability factors has not been generated for the first computing system, selecting the identified set of first processor scalability factors for use in modeling performance of the first computing system.

9. The method of claim 2, further comprising:
generating individual sets of processor scalability factors for the computer systems in the second set that are different from the identified set of first processor scalability factors; and
selecting a set of processor scalability factors for use in modeling performance of a first computing system, wherein selecting the set of processor scalability factors comprises:
determining if an individual set of processor scalability factors has been generated for the first computing system; and
in response to determining that an individual set of processor scalability factors has not been generated for the first computing system, determining a processor type of the first computing system, determining if the identified second set of processor scalability factors corresponds to the processor type of the first computing system, and in response to determining that the second set of processor scalability factors corresponds to the processor type of the first computing system, selecting the identified set of second processor scalability factors for use in modeling performance of the first computing system.

10. A method, comprising:
identifying a generic scalability model comprising a set of generic processor scalability factors that models performance of a number of computing systems out of a set of computing systems to within a predefined accuracy;
determining if any computing systems of the set of computing systems exist that are not modeled by the set of generic processor scalability factors to within the predefined accuracy; and
in response to determining that at least some computing systems of the set of computing systems are not modeled by the set of generic processor scalability factors to within the predefined accuracy:
(a) dividing the at least some computing systems into a plurality of groups based on a plurality of processor types; and
(b) identifying general scalability models comprising sets of processor scalability factors for each of the plurality of processor types, wherein the general scalability models model performance of a plurality of computing systems of the respective plurality of groups to within the predefined accuracy.

11. The method of claim 10, wherein the generic processor scalability factors comprise linear and exponential processor scalability factors.

12. The method of claim 10, wherein the generic processor scalability factors comprise chip scalability factors, core scalability factors and/or thread scalability factors.

13. The method of claim 10, further comprising:
for each processor type, determining if any computing systems in the group of computing systems exist that are not modeled by the general scalability models to within the predefined accuracy; and
in response to determining that at least some computing systems in the group of computing systems are not modeled by the general scalability models to within the predefined accuracy:
(c) dividing the at least some computing systems into a plurality of second groups based on a plurality of processor series; and
(d) identifying second general scalability models for each of the plurality of processor series, wherein the second general scalability models model performance of a plurality of computing systems of the respective plurality of second groups to within the predefined accuracy.

14. A computer program product, comprising:
a non-transitory computer readable storage medium comprising computer readable program code embodied in the medium that when executed by a processor of a computing device causes the processor to perform operations comprising:
identifying a generic scalability model comprising a set of generic processor scalability factors that models performance of a number of computing systems out of a set of computing systems to within a predefined accuracy;
determining if any computing systems of the set of computing systems exist that are not modeled by the set of generic processor scalability factors to within the predefined accuracy; and
in response to determining that at least some computing systems of the set of computing systems are not modeled by the set of generic processor scalability factors to within the predefined accuracy:
(a) dividing the at least some computing systems into a plurality of groups based on a plurality of processor types; and
(b) identifying a general scalability model for each of the plurality of processor types, wherein the general scalability models model performance of a plurality of computing systems of the respective plurality of groups to within the predefined accuracy.

15. The computer program product of claim 14, wherein the generic processor scalability factors comprise linear and exponential processor scalability factors.

16. The computer program product of claim 14, wherein the generic processor scalability factors comprise chip processor scalability factors, core processor scalability factors and/or thread processor scalability factors.

17. The computer program product of claim 14, wherein the computer readable program code further causes the processor to perform operations comprising:
for each processor type, determining if any computing systems in the group of computing systems exist that are not modeled by general scalability models to within the predefined accuracy; and
in response to determining that at least some computing systems in the group of computing systems are not modeled by the general scalability models to within the predefined accuracy:
(c) dividing the at least some computing systems into a plurality of second groups based on a plurality of processor series; and
(d) identifying second general scalability models for each of the plurality of processor series, wherein the general scalability models model performance of a plurality of computing systems of the respective plurality of second groups to within the predefined accuracy.

18. A computer program product, comprising:
a non-transitory computer readable storage medium comprising computer readable program code embodied in the medium that when executed by a processor of a computing device causes the processor to perform operations comprising:
obtaining speed and throughput benchmark values for a plurality of computing systems, each of the computing systems comprising a processor;
generating a plurality of sets of first processor scalability factors;
for each set of first processor scalability factors:
(a) generating, for each computing system of the plurality of computing systems, a predicted throughput value based on the set of first processor scalability factors and the speed benchmark value of the computing system; and
(b) comparing the throughput benchmark value to the predicted throughput value for each of the plurality of computing systems;
identifying a set of first processor scalability factors from among the plurality of sets of first processor scalability factors for which, for a largest number of the computing systems, the predicted throughput value of the computing systems is less than a predetermined difference from the throughput benchmark value of the computing systems;
grouping computing systems for which the predicted throughput value is less than the predetermined difference from the throughput benchmark value into a first set and grouping remaining computing systems for which the predicted throughput value is greater than the predetermined difference from the throughput benchmark value into a second set; and
assigning the identified set of first processor scalability factors to the computing systems in the first set.

19. The computer program product of claim 18, wherein the computer readable program code further causes the processor to perform operations comprising:
dividing the computing systems in the second set into a plurality of third sets of computing systems based on processor type;
selecting one set of the plurality of third sets of computing systems;
generating a plurality of sets of second processor scalability factors;
for each set of second processor scalability factors:
(c) generating a predicted throughput value for each of the plurality of computing systems in the selected third set of computing systems based on the set of second processor scalability factors and the speed benchmark value of the respective computing system; and
(d) comparing the throughput benchmark value to the predicted throughput value for each of the plurality of computing systems in the selected third set of computing systems;
identifying a set of second processor scalability factors from among the plurality of sets of second processor scalability factors for which, for a largest number of the computing systems in the selected third set of computing systems, the predicted throughput value of the computing systems is less than the predetermined difference from the throughput benchmark value of the computing systems in the selected third set of computing systems;
grouping computing systems for which the predicted throughput value is less than the predetermined difference from the throughput benchmark value into a fourth set and grouping remaining computer systems for which the predicted throughput value is greater than the predetermined difference from the throughput benchmark value into a fifth set; and
assigning the identified set of second processor scalability factors to the computing systems in the fourth set.

20. wherein the computer readable program code further causes the processor to perform operations comprising:
repeating the identification of second processor scalability factors for each processor type.
